(19) United States
(12) Patent Application Publication
(10) Pub. No.: US 2013/0191144 A1
(43) Pub. Date: Jul. 25, 2013

(54) MEDICAL SUPPLY MANAGEMENT APPARATUS, MEDICAL SUPPLY MANAGEMENT SYSTEM AND CONTROL METHOD

(71) Applicant: TOSHIBA TEC KABUSHIKI KAISHA, Tokyo (JP)

(72) Inventors: Natsuko Iwamoto, Kanagawa-ken (JP); Katsuyuki Suzuki, Shizuoka-ken (JP); Shunichiro Kawamoto, Shizuoka-ken (JP)

(73) Assignee: TOSHIBA TEC KABUSHIKI KAISHA, Tokyo (JP)

(21) Appl. No.: 13/744,528

(22) Filed: Jan. 18, 2013

(30) Foreign Application Priority Data
Jan. 19, 2012 (JP) 2012-009035

(51) Int. Cl. G06Q 50/22

(52) U.S. Cl. CPC G06Q 50/22; G06Q 10/087
USPC 705/2

(57) ABSTRACT

A medical supply management apparatus comprises a medical supply specifying unit configured to specify a medical supply carried in a specified carrying-in area, a discrimination unit configured to discriminate whether or not the medical supply specified by the medical supply specifying unit is included in a medical supply predetermined to be carried in the carrying-in area and an informing unit configured to inform the information needed to specify the medical supply that is not included in a medical supply predetermined to be carried in and the message that the medical supply carried in is not included in a medical supply predetermined to be carried in, when the medical supply which is not included in the medical supply predetermined to be carried in is carried in according to the discrimination result of the discrimination unit.

### CROSS-REFERENCE TO RELATED APPLICATION

This application is based upon and claims the benefit of priority from Japanese Patent Application. No. 2012-009035, filed Jan. 19, 2012, the entire contents of which are incorporated herein by reference.

### FIELD

Embodiments described herein relate to a medical supply management apparatus, a medical supply management system and a control method.

### BACKGROUND

Formerly, a management system (for instance, refer to a patent literature 1) managing a medical supply such as a medicine supply, a medical appliance and the like in a hospital was provided.

The former management system took the inventory management of the medicine supply and the like as its main purpose.

### BRIEF DESCRIPTION OF THE DRAWINGS

FIG. 1 is a sketchy structural block diagram of a medical supply management system of an embodiment;

FIG. 2 is a sketchy structural block diagram of a handy terminal;

FIG. 3 is a sketchy structural drawing of a gate apparatus;

FIG. 4 is an appearance view of the gate apparatus;

FIG. 5 is a timing chart of a first embodiment;

FIG. 6 is an explanatory drawing of a display example in the gate apparatus;

FIG. 7 is a drawing showing one example of a display example of a warning screen in a display screen of a display of the gate apparatus;

FIG. 8 is an explanatory drawing of one example of a display screen of the handy terminal when a medical supply of a carried-in object is added; and

FIG. 9 is a timing chart of a second embodiment.

### DETAILED DESCRIPTION

According to one embodiment, a medical supply specifying unit of a medical supply management specifies a medical supply carried in a specified carrying-in area.

As a result of these acts, a discrimination unit discriminates whether or not the medical supply specified by the medical supply specifying unit is included in a medical supply predetermined to be carried in the carrying-in area. An informing unit informs the information needed to specify the medical supply that is not included in a medical supply predetermined to be carried in and the message that the medical supply carried in is not included in a medical supply predetermined to be carried in, when the medical supply which is not included in the medical supply predetermined to be carried in is carried in according to the discrimination result of the discrimination unit.

Hereinafter, further embodiments will be described with reference to the drawings.

### A First Embodiment

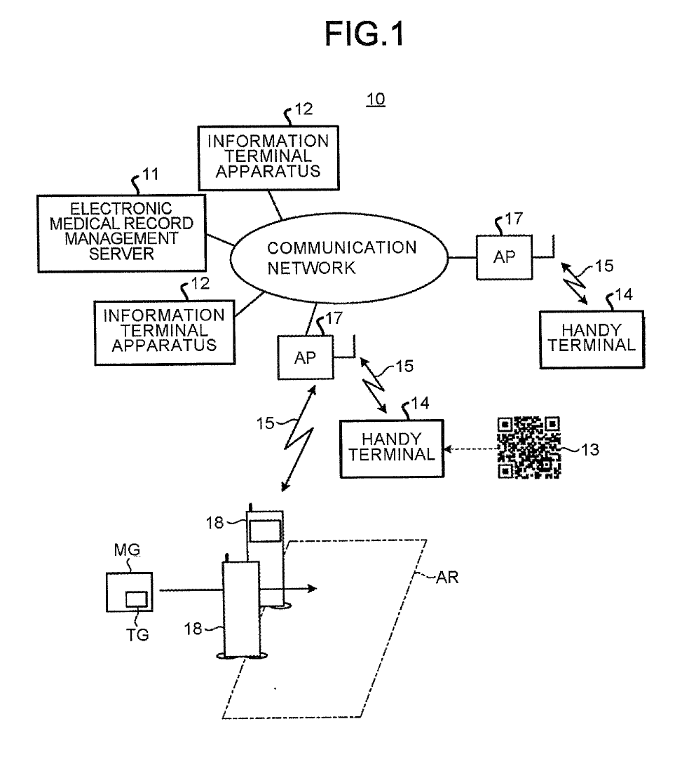

FIG. 1 is a sketchy structural block diagram of a medical supply management system of the embodiment.

The medical supply management system 10 is approximately divided and comprises: an electronic medical record management server 11 configured to manage an electronic medical record (database) ; a plurality of information terminal apparatuses 12 configured to be used for a physician and the like to carry out input and a read-out operation on the electronic medical record; a tag for patient 13 configured to be worn at the wrist and the like of a patient and simultaneously symbolize an information code used for determining the patient, such as the ID and the like of the patient, for displaying; a plurality of handy terminals 14 configured to be respectively carried by a nurse and the like, input various kinds of information including the patient ID used for determining the patient or prompt information used for determining the medical supply which shall be used for the patient; a plurality of access points 17 configured to be configured in a hospital, so as to connect the handy terminals 14 with the electronic medical record management server 11 through a wireless communication network 15 and a communication network 16; and a gate apparatus 18 configured to be arranged at an entrance of a chamber (carrying-in area AR) using the medical supply, such as a consultation room, a treatment room or an operating room and the like, specify the medical supply carried in the chamber (in the carrying-in area AR), and simultaneously prompt information relevant with the medical supply which shall be carried in the chamber.

Herein, the gate apparatus 18 forms the medical supply management apparatus and prompts information whether or not the medical supply MG carried in the carrying-in area AR is suitable, and the like.

In the present invention, the so-called medical supply is a concept including a medicine supply specified in a pharmaceutical affairs law, a medical cosmetic (quasi drug), blood for blood transfusion, a sanitation supply such as an operating appliance, a bandage and the like used in an operation, and various articles used in a medical treatment, such as a medical instrument and the like.

The electronic medical record management server 11 is formed as an information processing apparatus (a workstation, a computer) including and containing an MPU, a ROM, a RAM, an external storage unit of the electronic medical record database (DB) and a communication interface which are not shown in figures.

The information terminal apparatus 12 comprises: an information terminal apparatus main body formed as the information processing apparatus (the workstation, the computer) including the MPU, the ROM, the RAM, the external storage unit and the communication interface which are not shown in the figures, a display displaying the various kinds of information, an operation terminal carrying out various operations, and a printer printing and outputting the various kinds of information.

As the communication network 16, besides a public communication network such as the Internet and the like, it also can be formed by an in-mechanism LAN and the like, or also can be constructed by the combination of a plurality of communication networks, such as the communication of the Internet and the in-mechanism LAN.

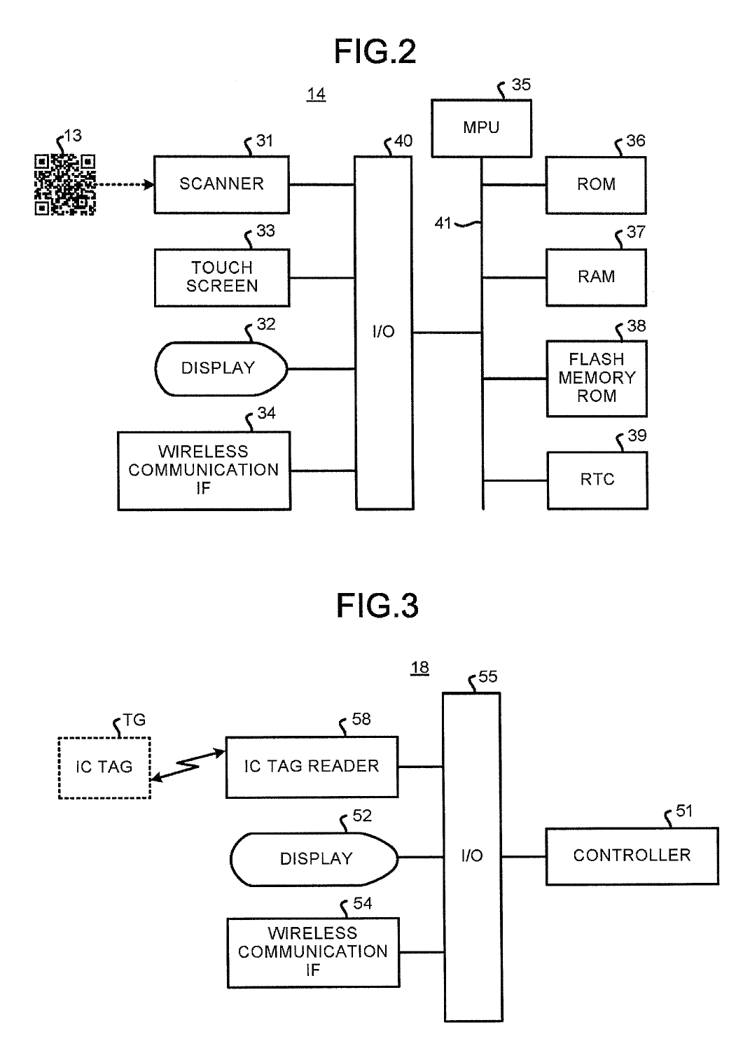

FIG. 2 is a sketchy structural block diagram of the handy terminal.

The handy terminal 14 comprises: a scanner (a camera, a capturing apparatus) 31 used as a code symbol reading apparatus (a code symbol reading apparatus) and reading a code symbol such as a two-dimensional bar code and the like from the tag for patient 13 and the like; a display 32 used for displaying various kinds of information; a touch screen 33 integrally forming a touch screen display with the display 32 and used for a user to carry out the various operations; and a wireless communication interface unit (IF) 34 carrying out a wireless communication interface action with the access point 17 or with the gate apparatus 18.

In addition, the handy terminal 14 comprises: an MPU 35 controlling the whole handy terminal 14; a ROM 36 storing various data such as a control program and the like in a nonvolatile way; a RAM 37 used as a working area and temporarily storing the various data; a flash memory ROM 38 storing a firmware, various setting data and the like in a nonvolatile and renewable way; a real-time clock (RTC) 39 which is connected with a standby power supply not shown in the figures, also can continuously count a current moment even though in the state that a power supply of the handy terminal 14 is turned off, and inputs current moment data in the MPU 35 in the state that the power supply is turned on; and an input/output interface unit (I/O) 40 carrying out an interface action among the scanner 31, the display 32 and the touch screen 33.

Herein, the MPU 35 is connected with the ROM 36, the RAM 37, the flash ROM 38, the real-time clock 39 and the input/output interface unit (I/O) 40 through a bus line 41.

In addition, the MPU 35 plays roles as a control apparatus, uses the patient ID read from the tag for patient 13 to carry out inquiry on the electronic medical record management server 11, and acquires the information determining the medical supply MG used by the patient specified by the tag for patient 13 from the electronic medical record management server 11.

Next, the sketchy structure of the gate apparatus 18 is described.

FIG. 3 is a sketchy structural drawing of the gate apparatus.

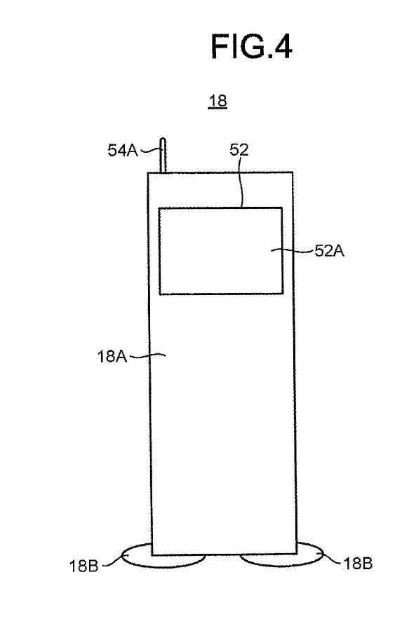

FIG. 4 is an appearance view of the gate apparatus.

An apparatus main body 18A of the gate apparatus 18 internally comprises: a controller 51 controlling the whole gate apparatus 18; a display 52 displaying the various kinds of information under the control of the controller 51; an IC tag reader 58 reading out the information used for determining the medical supply from an IC tag (RFID tag) TG previously arranged in the medical supply MG; a wireless communication interface unit (IF) 54 carrying out the wireless communication interface action with the access point 17 or with the handy terminal 14; and an input/output interface unit (I/0) 55 connecting the controller 51 with the display 52, the IC tag reader 58 and the wireless communication interface unit 54.

In the structure, the controller 51 is formed as the information processing apparatus (the computer) including the MPU, the ROM, the RAM and the external storage unit which are not shown in the figures, and the MPU stores the data and the like needed for backup in the external storage unit formed by the flash memory ROM and the like and processes the data while using the RAM as the working area according to the control program stored in the ROM.

In addition, a foot unit 18B is arranged at the lower part of the apparatus main body 18A and can be independently arranged in a standing way at the entrance of the carrying-in area AR such as the chamber and the like. In addition, an external antenna 54A connected with the wireless communication interface unit 54 is arranged at the upper part of the apparatus main body 18A.

Subsequently, the actions of the first embodiment are described.

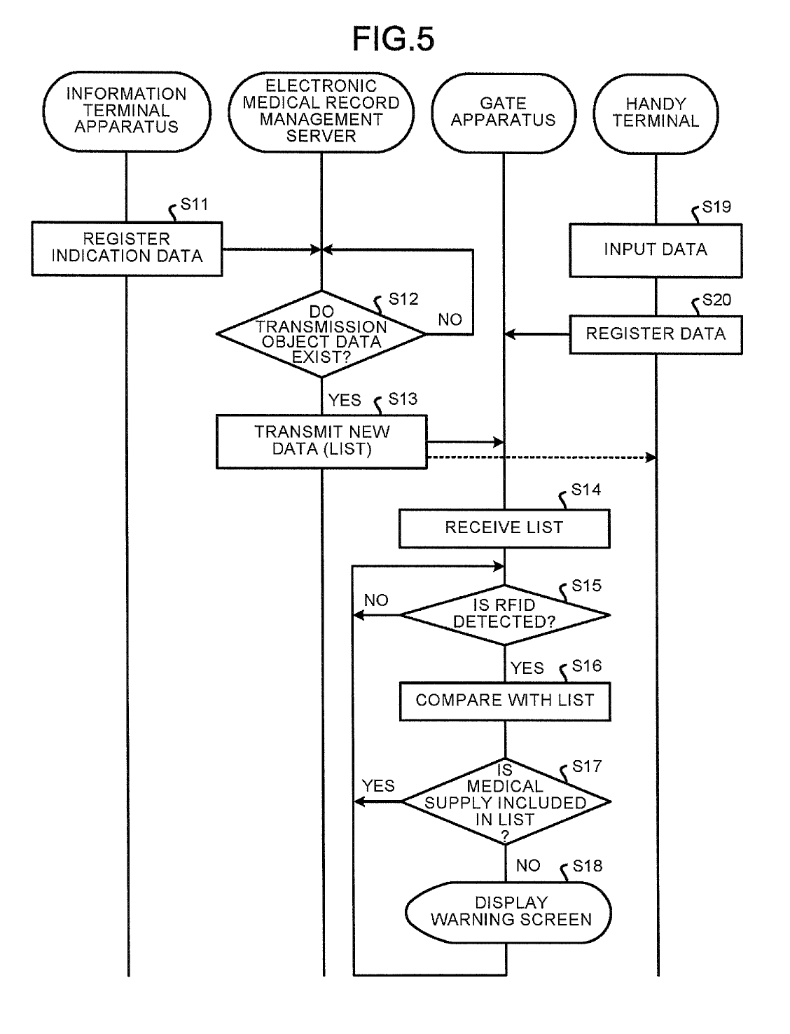

FIG. 5 is a timing chart of the first embodiment. First, the physician corresponds indication data corresponding to indications (an operation indication, a handling indication, an examination indication and the like) corresponding to expected treatment and consultation contents to the patient ID used for determining the patient through the information terminal apparatus 12 and registers the indication data in the electronic medical record database of the electronic medical record management server 11 (Act S11).

Thus, the electronic medical record management server 11 registers the indication data corresponding to the patient ID.

Herein, as the indication data, for instance, the variety and the quantity of the medical supply such as a medical appliance and the like represented by the medicine supply, a suture line, a gauze and the like used in the operation, and the variety and the like of the medical instrument used in the operation when the operation is carried out are included.

Subsequently, the electronic medical record management server 11 discriminates whether or not the data that needs to be transmitted exist in the handy terminal 14 or the gate apparatus 18, in the indication data registered in the electronic medical record database (Act S12).

In the discrimination of Act S12, if the data that needs to be transmitted do not exist in the handy terminal 14 or the gate apparatus 18, in the indication data registered in the electronic medical record database (Act S12; No), the electronic medical record management server becomes a standby state.

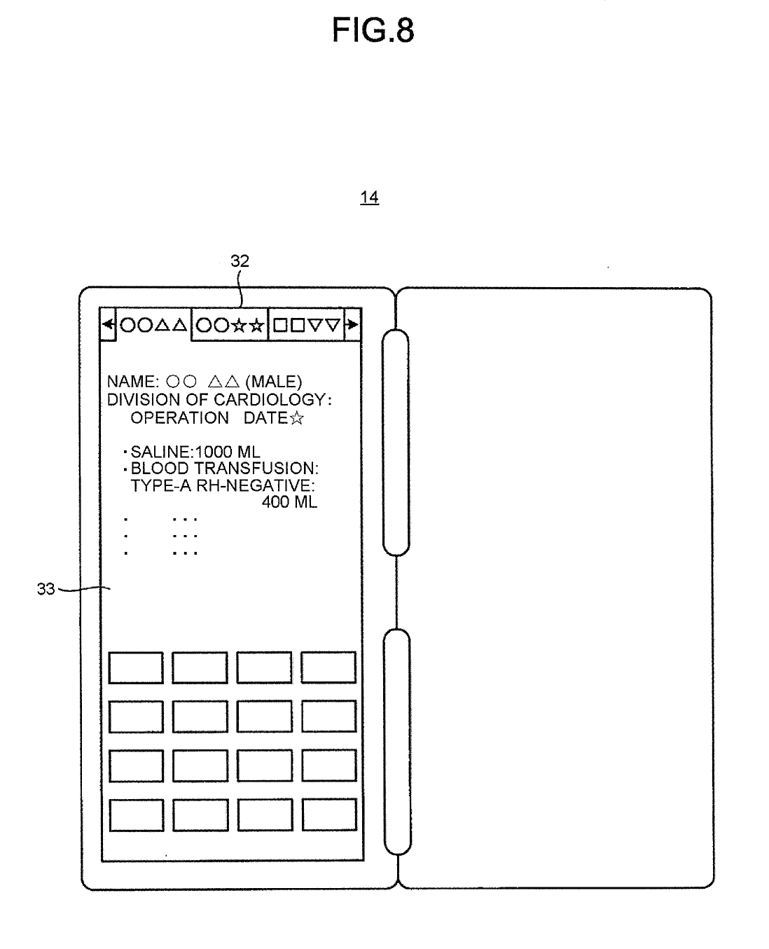

In the discrimination of Act S12, if the data that needs to be transmitted exists in the handy terminal 14 or the gate apparatus 18, in the indication data registered in the electronic medical record database (Act S12; Yes), the electronic medical record management server 11 transmits new data (a list) to the handy terminal 14 or the gate apparatus 18 through the communication network 16 and the access point 17 (Act S13). In addition, a display screen aiming at the moment when the data are transmitted to the handy terminal 14 refers to FIG. 8.

As a result, the gate apparatus 18 receives the list of the medical supply predetermined to be carried in the carrying-in area AR corresponding to the gate apparatus 18 (Act S14).

The gate apparatus 18 receiving the list discriminates whether or not the IC tag TG entering the carrying-in area AR corresponding to the gate apparatus 18 is detected, that is, whether or not the medical supply MG attached with the IC tag TG is carried in the carrying-in area AR corresponding to the gate apparatus 18 (Act S15).

In the discrimination of Act S15, if the medical supply attached with an RFID is not carried in the carrying-in area AR corresponding to the gate apparatus 18 (Act S15; No), the gate apparatus 18 becomes the standby state.

In the discrimination of Act S15, if the medical supply MG attached with the IC tag TG is carried in the carrying-in area AR corresponding to the gate apparatus 18 (Act S15; Yes), the gate apparatus 18 is compared with the list received in Act S14 (Act S16).

Subsequently, the gate apparatus 18 discriminates whether or not the carried-in medical supply is the medical supply included in the list (Act S17).

In the discrimination of Act S17, if the medical supply carried in the carrying-in area AR is the medical supply included in the list (Act S17; Yes), the processing is transferred to Act S15 to carry out the same processing again.

In the discrimination of Act S17, if the medical supply carried in the carrying-in area AR is not the medical supply included in the list (Act S17; No), the information (a medical supply name, a model and the like) used for specifying the medical supply is displayed, simultaneously, a warning screen of a message that the medical supply which does not exist in carrying-in predetermination is carried in is displayed on the display screen of the display 52, and inform a carrying-in worker (Act S18).

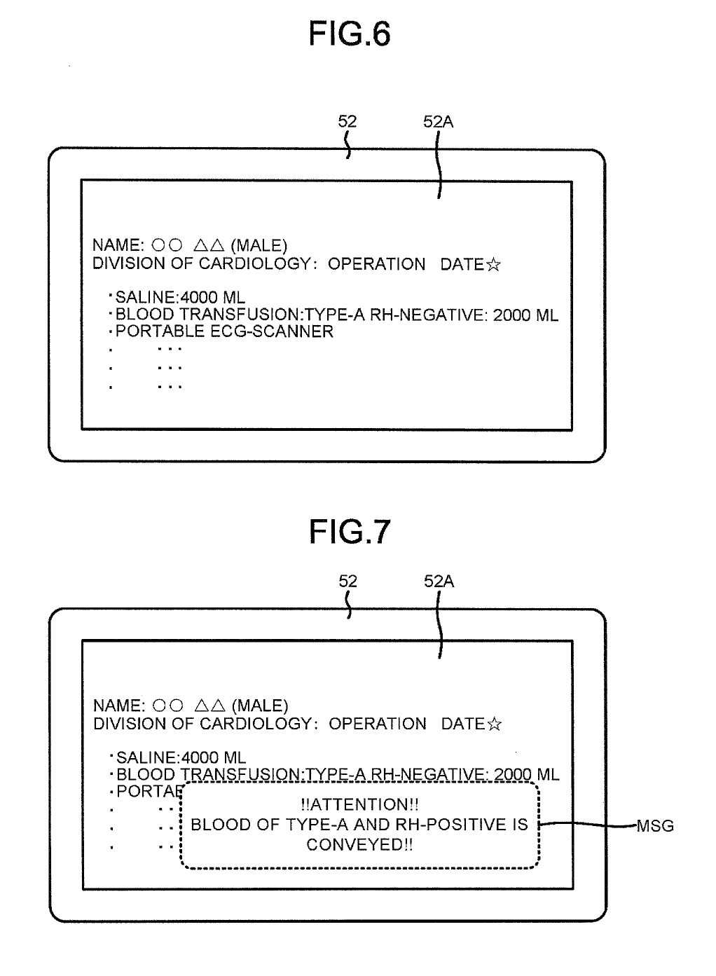

FIG. 6 is an explanatory drawing of a display example in the gate apparatus.

The name and the gender of the patient, a medical handling content (in FIG. 6, “division of cardiology: operation”), an operation predetermined date, a name of medical supply and a carried-in predetermined quantity are displayed, as shown in FIG. 6, on the display screen 52A of the display 52 of the gate apparatus 18. In addition, a non-carried-in quantity relative to the carried-in predetermined quantity also can be displayed as required.

Herein, if the medical supply which does not exist in the carrying-in predetermination (does not exist in the list) is carried in, the information specifying the medical supply is displayed, and a warning is displayed simultaneously.

FIG. 7 is a drawing showing one example of a display example of the warning screen in the display screen of the display of the gate apparatus.

FIG. 7 is the display example of the case that the blood type of the blood for the blood transfusion in the carrying-in predetermination indicated by the indication data is type-A Rh-negative, although the blood type which is type-A Rh-positive is carried in.

As shown in FIG. 7, as the warning screen, a message MSG specified according to the IC tag TG in a carrying-in process, further meaning that the blood for the blood transfusion, which does not exist in the carrying-in predetermination (list) and whose blood type is the type-A Rh-positive is carried in, and used for calling attention is displayed on the display screen 52A of the display 52.

As a result, the carrying-in worker can easily know the condition that the medical supply which shall not be carried in the carrying-in area (or is not expected to be carried in) is included, and as the warning is formed at a carrying-in moment, the medical supply cannot be used for the patient wrongly.

At the moment, by displaying not only the category of medical supply but also the model number or the carried-in quantity, if necessary, includes the deficit quantity or the surplus quantity, it becomes easy and fast to cope with the problem of supplying a deficiency and the like.

In addition, as another illustrative embodiment of warning display, the medical supply (the blood for the blood transfusion in the present example) which does not exist in the carrying-in predetermination can be displayed in a flicker way, or is altered in color or is surrounded by a frame to be displayed, and the like. In addition, the warning display not only can be carried out, but also a buzz sound also can be given out, or a lamp is enabled to flicker.

FIG. 8 is an explanatory drawing of one example of a display screen of the handy terminal when a medical supply of a carried-in object is added.

In addition, when the medical supply of the carried-in object is added on the spot, as shown in FIG. 8, a list (in FIG. 8, 1000 ml of saline and 400 ml of the blood for the blood transfusion, whose blood type is type-A Rh-negative, are added) of the medical supply which shall be added is made; as shown in FIG. 5, an operator (the physician, the nurse and the like) inputs data corresponding to the medical supply of an added object by using the handy terminal 14 (Act S19) and registers the gate apparatus 18 (Act S20), so that the processing also can be carried out aiming at the added medical supply the same as the previously appointed medical supply.

In addition, when the medical supply of the carried-in object is altered according to a later indication, the condition representing that the medical supply which shall be carried in is altered is displayed, and simultaneously, the display is carried out in the way of making the difference of the medical supply after the alternation and the medical supply before the alternation explicit. Particularly, on the medical supply before the alternation, a double strikethrough is displayed in an overlapping way, an arrow facing to the medical supply after the alternation from the medical supply before the alternation is displayed, and simultaneously, the medical supply after the alternation is displayed.

In addition, when the medical supply of the carried-in object, which is not necessary to be carried in, is cancelled, the display is carried out in the way of making the information of not carrying in the medical supply explicit. Particularly, aiming at the medical supply not necessary to be carried in, the double strikethrough is displayed in the overlapping way.

As described above, according to the present first embodiment, the medical supply carried in the carrying-in area is specified, the medical supply (the medical supply included in a carrying-in list) which is predetermined to be carried in and the medical supply which is not predetermined to be carried in are recognized, whether or not the carrying in is proper is displayed, therefore, the medical supply which shall be carried in assuredly can be specified, and simultaneously, the coping also can be quickly carried out aiming at the wrong carrying-in or the condition that the insufficiency of the carried-in quantity occurs.

### A Second Embodiment

In the description of the first embodiment above, aiming at the list of the medical supply of the carrying-in predetermination, a structure of being automatically transmitted from the electronic medical record management server 11 is adopted, but the present second embodiment is the embodiment that the gate apparatus 18 automatically acquires the list from the electronic medical record management server 11 by registering the information (such as the patient ID) determining the patient in the gate apparatus 18 by the handy terminal 14.

By adopting such a structure, even though in the condition that the carrying-in area AR is not previously specified, the carrying in of the medical supply also can be carried out similarly at the moment when the carrying-in area is specified.

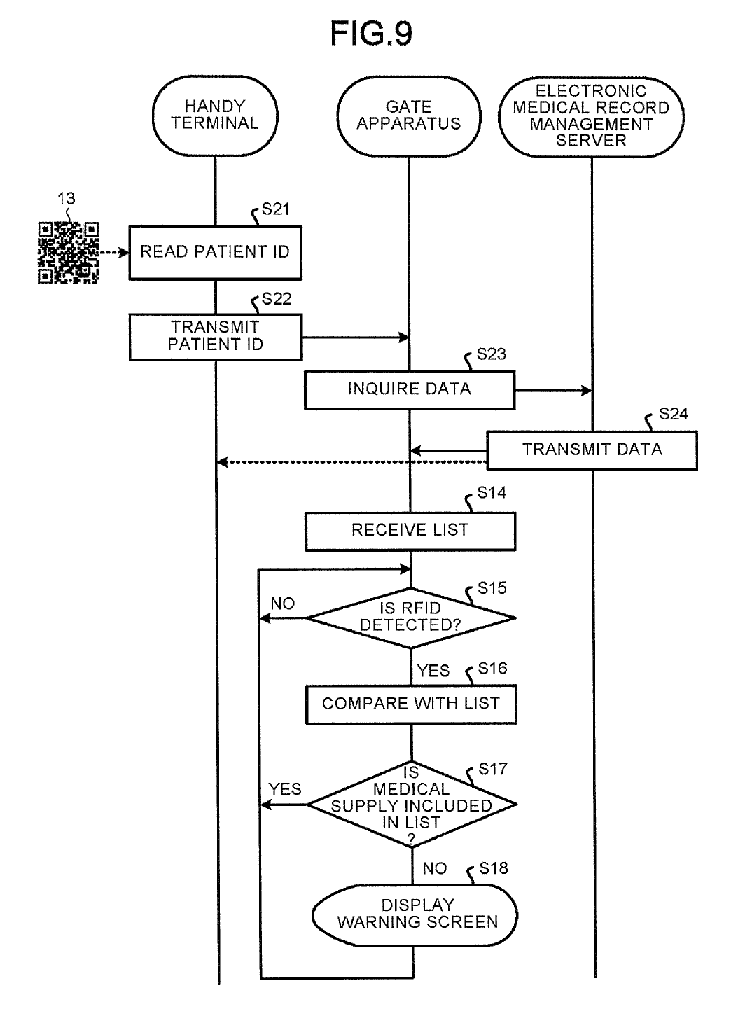

FIG. 9 is a timing chart of the second embodiment.

First, the nurse and the like as the operator of the handy terminal 14 read the patient ID from the tag for patient 13 worn on the body of the patient through the scanner 31 (Act S21).

Thus, the MPU 35 of the handy terminal 14 transmits the patient ID to the gate apparatus 18 through the wireless communication interface unit 34 (Act S22).

Thus, the controller 51 of the gate apparatus 18 inquires the electronic medical record management server 11 by using the patient ID through the wireless communication interface unit 54 (Act S23).

Thus, if the data that needs to be transmitted and corresponds to the patient ID of the inquiry exists, in the indication data registered in the electronic medical record database, the electronic medical record management server 11 transmits a data (a list) to the gate apparatus 18 which makes the inquiry through the communication network 16 and the access point 17 (Act S24).

As a result, the gate apparatus 18 receives the list of the medical supply predetermined to be carried in the carrying-in area AR corresponding to the gate apparatus 18 (Act S14).

Moreover, after the list is received, the controller 51 of the gate apparatus 18 discriminates whether or not the IC tag TG entering the carrying-in area AR corresponding to the controller is detected, that is, whether or not the medical supply MG attached with the IC tag TG is carried in the carrying-in area AR corresponding to the controller (Act S15), and when the medical supply MG attached with the IC tag TG is carried in the carrying-in area AR corresponding to the controller (Act S15; Yes), the medical supply MG is compared with the list received in the Act S14 (Act S16).

Subsequently, the gate apparatus 18 discriminates whether or not the carried-in medical supply is the medical supply included in the list (Act S17), when the medical supply carried in the carrying-in area AR is the medical supply included in the list (Act S17; Yes), the processing is carried out again, the processing is transferred to the Act S15 to carry out the same processing, when the medical supply carried in the carrying-in area AR is not the medical supply included in the list (Act S17; No), the information (the medical supply name, the model number and the like) used for determining the medical supply is displayed, simultaneously, the warning screen of the message that the medical supply which does not exist in the carrying-in predetermination is carried in is displayed on the display screen of the display 52, and informed the carrying-in worker (Act S18).

As described above, according to the present second embodiment, even though in the condition that the carrying-in area AR is not previously specified, the carrying in of the medical supply also can be carried out similarly at the moment when the carrying-in area is specified, the medical supply carried in the carrying-in area is specified, the medical supply (the medical supply included in the carrying-in list) which is predetermined to be carried in and the medical supply which is not predetermined to be carried in are recognized, whether or not the carrying in is proper is displayed, therefore, the medical supply which shall be carried in assuredly can be specified, and simultaneously, the coping also can be quickly carried out aiming at the wrong carrying-in or the condition that the insufficiency of the carried-in quantity occurs.

### A Variation of the Embodiment

In the above description, the condition that the message is warned by the display, a buzz or the lamp is described aiming at the moment when the medical supply which is not predetermined to be carried in is carried in, but the warning also can be carried out by a sound.

At the moment, the sound also can be altered (for instance, a female sound is changed into a male sound and the like) according to a warning content (the medical supply which shall not be carried in is carried in, the quantity of the medical supply of the carried-in object is insufficient, and the like).

In another first embodiment of the medical supply management apparatus of the embodiment also can comprise: the medical supply specifying unit (the IC tag reader, an RFID reader and the scanner) configured to specify the medical supply carried in the specified carrying-in area (the chamber, a warehouse, the operating room and the like); the discrimination unit (the controller, a microprocessor) configured to discriminate whether or not the medical supply specified by the medical supply specifying unit is included in the medical supply predetermined to be carried in the carrying-in area; and the informing unit (a display apparatus, a buzz generation apparatus, the lamp, a sound output apparatus) configured to inform information determining that the carried-in medical supply is not predetermined and information that the medical supply is carried in according to the discrimination result of the discrimination unit when the medical supply which is not included in the medical supply predetermined to be carried in is carried in.

In another second embodiment of the medical supply management apparatus of the embodiment, the medical supply predetermined in the carrying in also can correspond to the patient (patient specifying information, the patient ID) who shall use the medical supply.

In another third embodiment of the medical supply management apparatus of the embodiment, the informing unit also can comprise the display apparatus (the display apparatus, the display) which displays the information determining that the carried-in medical supply is not predetermined and the information that the medical supply is carried in.

In another fourth embodiment of the medical supply management apparatus of the embodiment, the medical supply management apparatus also can comprise: a communication apparatus (a wireless communication apparatus, a wire communication apparatus, a wireless communication interface, a wire communication interface) configured to previously receive the list of the medical supply predetermined to be carried in the carrying-in area through the communication network; and a storage unit (a memory, a hard disk, the external storage unit) configured to store the received list; and the discrimination unit (the controller, the microprocessor) carries out the discrimination according to the list stored in the storage unit.

In another first embodiment of the medical supply management system of the embodiment, the medical supply management system also can comprise: a server (the information processing apparatus) configured to comprise: a list storage unit configured to be predetermined to be carried in the specified carrying-in area and simultaneously store the list of the medical supply corresponding to the patient, and a list transmission apparatus configured to transmit the list through the communication network; and the medical supply management apparatus (the computer, the information processing apparatus, an information processing system) configured to comprise a list reception apparatus (a communication interface, the communication apparatus [wire, wireless]) configured to previously receive the list through the communication network, the medical supply specifying unit configured to specify the medical supply carried in the carrying-in area, the discrimination unit (the controller, the microprocessor) configured to discriminate whether or not the medical supply specified by the medical supply specifying unit is included in the medical supply predetermined to be carried in the carrying-in area according to the list, and the informing unit (the display apparatus, the buzz generation apparatus, the lamp, the sound output apparatus) configured to inform the information determining that the carried-in medical supply is not predetermined and inform the message that the medical supply is carried in according to the discrimination result of the discrimination unit when the medical supply which is not included in the medical supply predetermined to be carried in is carried in.

The control program executed by the medical supply management apparatus of the embodiment is a control program used for controlling the medical supply management apparatus by the computer; the medical supply management apparatus comprises the storage unit storing the list of the medical supply received through the communication network, predetermined to be carried in the specified carrying-in area and corresponding to the patient; the computer also can be enabled to play the roles as the following apparatuses, that is, the medical supply specifying unit determining the medical supply carried in the specified carrying-in area, the discrimination unit discriminating whether or not the medical supply specified by the medical supply specifying unit is included in the medical supply predetermined to be carried in the carrying-in area, and the informing unit informing the information determining that the carried-in medical supply is not predetermined and the message that the medical supply is carried in according to the discrimination result of the discrimination unit when the medical supply which is not included in the medical supply predetermined to be carried in is carried in.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical supply management apparatus, comprising:
a medical supply specifying unit configured to specify a medical supply carried in a specified carrying-in area;
a discrimination unit configured to discriminate whether or not the medical supply specified by the medical supply specifying unit is included in a medical supply predetermined to be carried in the carrying-in area; and
an informing unit configured to inform the information needed to specify the medical supply that is not included in a medical supply predetermined to be carried in and the message that the medical supply carried in is not included in a medical supply predetermined to be carried in, when the medical supply which is not included in the medical supply predetermined to be carried in is carried in according to the discrimination result of the discrimination unit.

2. The medical supply management apparatus according to claim 1, wherein
the medical supply predetermined to be carried in is related to a patient in need thereof.

3. The medical supply management apparatus according to claim 1, wherein
the informing unit includes a display unit configured to display the information needed to specify the medical supply that is not included in a medical supply predetermined to be carried in and the message that the medical supply carried in is not included in a medical supply predetermined to be carried in.

4. The medical supply management apparatus according to claims 1, further comprising:
a communication apparatus configured to previously receive a list of the medical supply predetermined to be carried in the carrying-in area through a communication network; and
a storage unit configured to store the received list, wherein
the discrimination unit carries out the discrimination according to the list stored in the storage unit.

5. A medical supply management system, comprising:
a server includes a list storage unit configured to store a list of a medical supply predetermined to be carried in a specified carrying-in area and related to a patient, and a list transmission unit configured to transmit the list through a communication network; and
a medical supply management apparatus includes a list reception unit configured to previously receive the list through the communication network, a medical supply specifying unit configured to specify a medical supply carried in the carrying-in area, a discrimination unit configured to discriminate whether or not the medical supply specified by the medical supply specifying unit according to the list is included in the medical supply predetermined to be carried in the carrying-in area and an informing unit configured to inform the information needed to specify the medical supply that is not included in a medical supply predetermined to be carried in and the message that the medical supply carried in is not included in a medical supply predetermined to be carried in, when the medical supply which is not included in the medical supply predetermined to be carried in is carried in according to the discrimination result of the discrimination unit.

6. A control method, used for controlling a medical supply management apparatus include a storage unit storing a list of a medical supply predetermined to be carried in a specified carrying-in area, related to a patient and received through a communication network, comprising:
specifying a medical supply carried in a specified carrying-in area;
discriminating whether or not the medical supply specified by the medical supply specifying unit is included in a medical supply predetermined to be carried in the carrying-in area; and
informing the information needed to specify the medical supply that is not included in a medical supply predetermined to be carried in and the message that the medical supply carried in is not included in a medical supply predetermined to be carried in, when the medical supply which is not included in the medical supply predetermined to be carried in is carried in according to the discrimination result of the discrimination unit.
